(19) United States
(12) Patent Application Publication
(10) Pub. No.: US 2026/0188159 A1
(43) Pub. Date: Jul. 2, 2026

(54) DISPLAY DEVICE AND CONTROL METHOD THEREOF

(71) Applicant: Guangzhou China Star Optoelectronics Semiconductor Display Technology Co., Ltd., Guangzhou (CN)

(72) Inventor: Wenfang LI, Guangzhou (CN)

(73) Assignee: Guangzhou China Star Optoelectronics Semiconductor Display Technology Co., Ltd., Guangzhou (CN)

(21) Appl. No.: 19/238,510

(22) Filed: Jun. 15, 2025

(30) Foreign Application Priority Data
Dec. 31, 2024 (CN) 202411999801.3

(51) Int. Cl. G09G 3/20

(52) U.S. Cl. CPC G09G 3/20; G09G 2310/0267; G09G 2310/08; G09G 2320/041; G09G 2330/021; G09G 2330/026; G09G 2340/0435

(57) ABSTRACT

A display device and a control method of the display device are provided and related to the field of display technologies. The method includes: refreshing a picture required to be displayed by a display panel according to a first refresh rate in response to a power-on command; and refreshing a picture required to be displayed by the display panel at a second refresh rate in response to satisfying the target condition. The first refresh rate is less than the second refresh rate.

### CROSS-REFERENCE TO RELATED APPLICATION

This application claims priority to Chinese Patent Application No. 202411999801.3 filed on Dec. 31, 2024. The aforementioned application is herein incorporated by references in its entirety.

### TECHNICAL FIELD

The present disclosure relates to the field of display technologies, and more particularly to a display device and a control method of the display device.

### BACKGROUND

With the popularity of display devices, the display devices are applied to more and more scenes, including low-temperature scenes. As shown in FIG. 1, due to the characteristic drift of thin film transistors (TFT) at a low temperature, the display device cannot be turned on at a low temperature or a power-on picture is abnormal, resulting in a display problem. In prior technology, in order to solve this display problem, a temperature compensation circuit is added to a power management integrated circuit (PMIC) of a display device. As shown in FIG. 2, a resistance value of a resistor R3 will change in low-temperature scenes, thus the PMIC switches to a higher VGH voltage (gate on voltage), so that the thin film transistors can be turned on normally and the display devices can be displayed normally. However, the temperature compensation circuit added will incur additional cost.

### SUMMARY

In a first aspect, a control method of a display device is provided by the embodiments of the present disclosure. The control method includes:
in response to a power-on instruction, refreshing a picture required to be displayed on a display panel according to a first refresh rate; and
in response to satisfying a target condition, refreshing a picture required to be displayed on the display panel at a second refresh rate;
where the first refresh rate is less than the second refresh rate.

In a second aspect, a display device is provided by the embodiments of the present disclosure. The display device includes a display panel and a timing controller. The timing controller is configured for:
in response to a power-on instruction, refreshing a picture required to be displayed on a display panel according to a first refresh rate; and
in response to satisfying a target condition, refreshing a picture required to be displayed on the display panel at a second refresh rate;
where the first refresh rate is less than the second refresh rate.

Beneficial effects of the embodiments of the present disclosure are at least illustrated as follows.

In the display device and the control method of the display device provided by the embodiments of the present disclosure, the picture of the display panel is controlled to be refreshed according to a smaller refresh rate during a power-on process, and the smaller refresh rate is switched to a larger refresh rate after the power-on process, so as to ensure the display effect after the display panel is powered on. Since the smaller refresh rate is adopted during the power-on process, a charging time of a thin film transistor during the power-on process can be prolonged. Especially for low-temperature scenes, the thin film transistor can be normally turned on by prolonging the charging time, thereby ensuring that the display device can be normally powered on. In the embodiments of the present disclosure, there is no need to add a temperature compensation circuit to compensate a gate on voltage of the thin film transistor, and the problem that the display device cannot be powered on normally in the low-temperature scenes can be solved based on an existing power management integrated circuit, thereby effectively saving the cost of the display device.

### BRIEF DESCRIPTION OF THE DRAWINGS

FIG. 1 is a schematic diagram of a current-voltage characteristic curve of a thin film transistor.

FIG. 2 is a schematic diagram of a temperature compensation circuit.

FIG. 3 is a flowchart of a control method of a display device according to the embodiments of the present disclosure.

FIG. 4 is a schematic diagram of a control method of a display device according to the embodiments of the present disclosure.

FIG. 5 is a schematic diagram of a display device according to the embodiments of the present disclosure.

FIG. 6 is a schematic diagram of a gate driving unit according to the embodiments of the present disclosure.

FIG. 7 is a schematic diagram of a driving timing according to the embodiments of the present disclosure.

FIG. 8 is a schematic diagram of another driving timing according to the embodiments of the present disclosure.

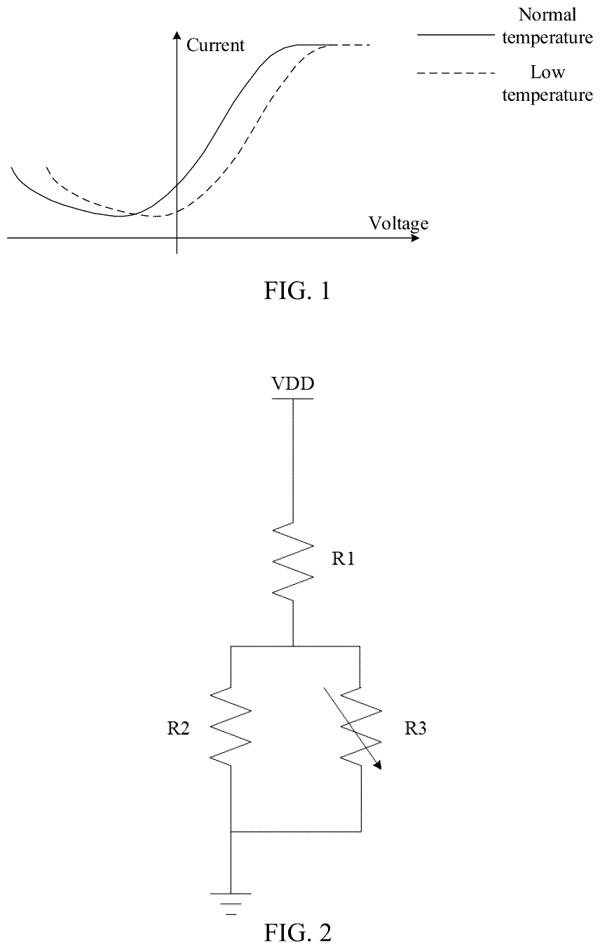

### DETAILED DESCRIPTION

The technical solutions in the embodiments of the present disclosure will be described hereinafter with reference to the accompanying drawings. The described technical solutions are merely used to illustrate and explain the idea of the present disclosure, and should not be regarded as limiting the present disclosure.

Additionally, the meaning of “plurality” is two or more in the description of the present disclosure. The terms “first” and “second” in the embodiments of the present disclosure are used to distinguish different technical features and do not indicate any order, quantity, or importance.

The various embodiments provided herein are similar, and features in different embodiments may be combined with each other.

The order of description of the following embodiments is not intended to limit the preferred order of the embodiments.

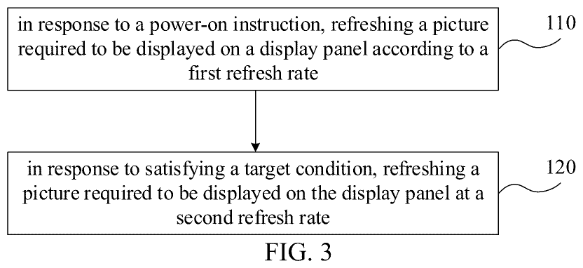

Referring to FIG. 3, FIG. 3 is a flowchart of a control method of a display device according to the embodiments of the present disclosure. As shown in FIG. 3, the control method of the display device includes:
step 110: in response to a power-on instruction, refreshing a picture required to be displayed on a display panel according to a first refresh rate; and
step 120: in response to satisfying a target condition, refreshing a picture required to be displayed on the display panel at a second refresh rate.

The power-on instruction may be an instruction generated according to a power-on operation of the user. The display device controls the picture of the display panel to be refreshed according to the first refresh rate in response to the power-on instruction. Thereafter, the display device controls the picture of the display panel to be refreshed according to the second refresh rate in response to satisfying the target condition. The first refresh rate is less than the second refresh rate. That is, in response to the power-on instruction, the display device first refreshes the picture to be displayed on the display panel at a smaller refresh rate, and then controls the picture to be displayed on the display panel at a larger refresh rate after satisfying the target condition. In the embodiments of the present disclosure, specific values of the first refresh rate and the second refresh rate are not limited, and can be flexibly set according to requirements in practical applications. For example, the first refresh rate is 165 Hz and the second refresh rate is 240 Hz. Alternatively, the first refresh rate is 75 Hz and the second refresh rate is 120 Hz.

The target condition is a preset condition for determining whether the display device is normally powered on. In some embodiments, the target condition includes that the picture is displayed on the display panel. That is, under a condition that the picture is displayed on the display panel, it is considered that the display device is normally powered on, and the first refresh rate is switched to the second refresh rate. Under a condition that no picture is displayed on the display panel, it is considered that the display device has not been powered on, and the picture of the display panel is controlled to be refreshed according to the first refresh rate. It should be understood that during a power-on process, the display device needs to complete a series of initialization operations, i.e., hardware detection, system loading, etc. As such, the display device generally needs to refresh a certain number of picture frames to complete the initialization operations. Although the display device needs to refresh the certain number of the picture frames during the power-on process of the display device, the display panel does not actually display the picture. Instead, the picture is displayed on the display panel after the display device is normally powered on.

In some embodiments, in order to quickly and accurately determine whether the display device is normally powered on, the target condition may include that the first refresh rate has been sustained for a preset duration. That is, under a condition that the first refresh rate has been sustained for the preset duration, it is considered that the display device is normally powered on. Otherwise, it is considered that the display device has not been powered on. The preset duration may be a duration obtained by pre-testing, so as to ensure that the display device can be normally powered on at the first refresh rate. For example, a duration required for normal power-on of the display device at the first refresh rate is tested in advance, and then the preset duration is set to be greater than or equal to the duration required for a normal power-on. In the practical applications, the preset durations may also be different corresponding to different first refresh rates. Optionally, the first refresh rate has a negative correlation with the preset duration. That is, the smaller the first refresh rate, the larger the preset duration. The larger the first refresh rate, the smaller the preset duration. For example, the first refresh rate is 165 Hz and the preset duration is 200 ms. Alternatively, the first refresh rate is 75 Hz and the preset duration is 300 ms. Certainly, in the practical applications, the preset durations corresponding to different first refresh rates may be the same. In this situation, the preset duration may be set as large as possible to ensure that the display device can be normally powered on during the power-on process performed according to various first refresh rates.

In some embodiments, in different application scenes, a smaller refresh rate may be used during the power-on process, and a larger refresh rate may be used after the power-on process. Alternatively, in some embodiments, a smaller refresh rate may be adopted during the power-on process in low-temperature scenes, and a larger refresh rate may be adopted after the power-on process, so as to prolong a charging time in the low-temperature scenes and ensure that the display device is normally powered on in the low-temperature scenes.

As a result, the above step 110 may include: obtaining an ambient temperature of the display panel in response to the power-on instruction; and under a condition that the ambient temperature is lower than a preset temperature, refreshing the picture required to be displayed on the display panel according to the first refresh rate. Accordingly, under a condition that the ambient temperature is greater than the preset temperature, the picture required to be displayed on the display panel is refreshed according to the second refresh rate, and it is not necessary to switch the refresh rate according to the target condition subsequently. That is, under a condition that the power-on instruction is received, it is first determined whether the display device is currently in the low-temperature scenes. Under the condition that the display device is in the low-temperature scenes, a smaller refresh rate is adopted during the power-on process. Under the condition that the display device is not in the low-temperature scenes, a larger refresh rate can also be used during the power-on process. For determining the low-temperature scenes, in the embodiments of the present disclosure, the ambient temperature of the display device is collected. Under a condition that the ambient temperature is lower than the preset temperature, it is considered that the display device is applied to the low-temperature scenes. In the embodiments of the present disclosure, a specific value of the preset temperature is not limited, and the preset temperature can be flexibly set according to the requirements in the practical applications. For example, the preset temperature can be minus 20 degrees Celsius, minus 18 degrees Celsius, minus 22 degrees Celsius, minus 5 degrees Celsius, minus 2 degrees Celsius, etc.

In some embodiments, the above step 110 may include: for each sub-pixel in the picture to be displayed on the display panel, driving the sub-pixel to be maintained on during a first turn-on period and driving the sub-pixel to be maintained off during a first turn-off period. A first display period corresponding to the first refresh rate includes the first turn-on period and the first turn-off period adjacent to each other.

In some embodiments, the above step 120 may include: for each sub-pixel in the picture to be displayed on the display panel, driving the sub-pixel to be maintained on during a second turn-on period and driving the sub-pixel to be maintained off during a second turn-off period. A second display period corresponding to the second refresh rate includes the second turn-on period and the second turn-off period adjacent to each other.

Since the first refresh rate is less than the second refresh rate, the first display period is greater than the second display period. Optionally, one display period of the sub-pixel includes one turn-on period and one turn-off period adjacent to each other. The display period may be increased by increasing the turn-on period of the sub-pixel, the display period may also be increased by increasing the turn-off period of the sub-pixel, or the display period may also be increased by increasing both the turn-on period and the turn-off period of the sub-pixel. That is, the first turn-on period is greater than the second turn-on period. Alternatively, the first turn-off period is greater than the second turn-off period. Alternatively, the first turn-on period is greater than the second turn-on period, and the first turn-off period is greater than the second turn-off period.

In summary, in the control method of the display device provided by the embodiments of the present disclosure, the picture of the display panel is controlled to be refreshed according to a smaller refresh rate during the power-on process, and the smaller refresh rate is switched to a larger refresh rate after the power-on process, so as to ensure the display effect after the display panel is powered-on. Since the smaller refresh rate is adopted during the power-on process, a charging time of a thin film transistor during the power-on process can be prolonged. Especially for the low-temperature scenes, the thin film transistor can be normally turned on by prolonging the charging time, thereby ensuring that the display device can be normally powered on. In the embodiments of the present disclosure, there is no need to add a temperature compensation circuit to compensate a gate on voltage of the thin film transistor, and the problem that the display device cannot be powered on normally in the low-temperature scenes can be solved based on an existing power management integrated circuit, thereby effectively saving the cost of the display device.

Hereinafter, a specific example will be used to introduce and explain the control method of the display device provided by the embodiments of the present disclosure.

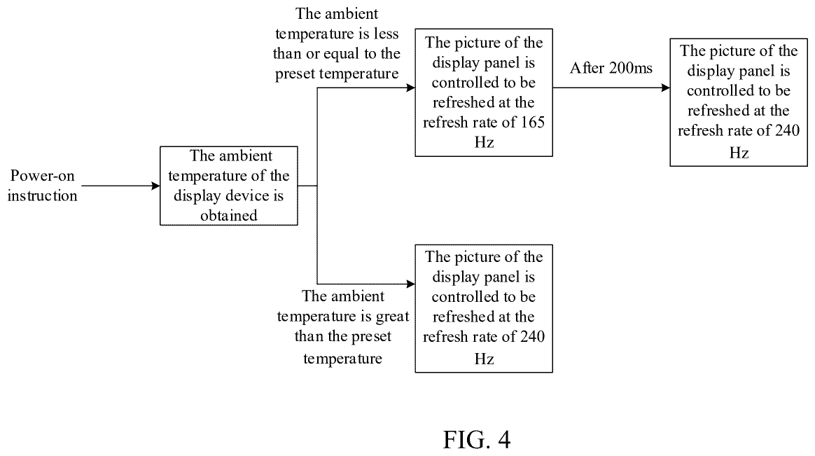

Exemplarily, as shown in FIG. 4, in response to the power-on instruction of the display device, the ambient temperature of the display device may be first obtained, and then the ambient temperature may be compared with the preset temperature. Under the condition that the ambient temperature is less than or equal to the preset temperature, the display device is applied to the low-temperature scenes. The picture of the display panel is controlled to be refreshed according to the refresh rate of 165 Hz first. After a duration of 200 ms, 165 Hz is switched to 240 Hz, and the picture of the display panel is controlled to be refreshed at the refresh rate of 240 Hz. Under the condition that the ambient temperature is greater than the preset temperature, the display device is applied to a normal temperature scene, and the picture of the display panel is directly controlled to be refreshed at the refresh rate of 240 Hz.

Referring to FIG. 5, FIG. 5 is a schematic diagram of a display device according to the embodiments of the present disclosure. As shown in FIG. 5, the display device 500 includes a display panel 510 and a timing controller 520.

The timing controller 520 is configured for: in response to a power-on instruction, refreshing a picture required to be displayed on a display panel 510 according to a first refresh rate; and in response to satisfying a target condition, refreshing a picture required to be displayed on the display panel 510 at a second refresh rate. The first refresh rate is less than the second refresh rate.

In some embodiments, as shown in FIG. 5, the display device 500 further includes a gate driving circuit 530 and a source driving circuit 540. The timing controller 520 and the source driving circuit 540 are electrically connected, and the timing controller 520 and the gate driving circuit 530 are electrically connected. The display panel 510 includes a plurality of scanning lines GL, a plurality of data lines DL, and a plurality of sub-pixels 511 arranged in an array. The source driving circuit 540 is electrically connected to the data lines DL. The gate driving circuit 530 is electrically connected to the scanning lines GL. Each of the sub-pixel 511 is electrically connected to a corresponding one of the scanning lines GL and a corresponding one of the data lines DL.

In some embodiments, the gate driving circuit 530 is configured for: for each sub-pixel 511 in the picture to be displayed on the display panel 510, driving the sub-pixel 511 to be maintained on during a first turn-on period and driving the sub-pixel 511 to be maintained off during a first turn-off period. A first display period corresponding to the first refresh rate includes the first turn-on period and the first turn-off period adjacent to each other.

In some embodiments, the gate driving circuit 530 includes a plurality of gate driving units in a cascaded configuration. Each of the gate driving units is connected to a clock signal and outputs a scanning signal. The timing controller 520 is further configured for: for each sub-pixel 511 in the picture to be displayed on the display panel 510, inputting a first timing signal corresponding to the sub-pixel 511 to the gate driving unit in the gate driving circuit 530. Each of the gate driving units in the gate driving circuit 530 is configured for: determining a first scanning signal corresponding to the sub-pixel 511 according to the first timing signal corresponding to the sub-pixel 511; and according to the first scanning signal corresponding to the sub-pixel 511, driving the sub-pixel 511 to be maintained on during the first turn-on period, and driving the sub-pixel 511 to be maintained off during the first turn-off period.

In some embodiments, the gate driving circuit 530 is configured for: for each sub-pixel 511 in the picture to be displayed on the display panel 510, driving the sub-pixel 511 to be maintained on during a second turn-on period and driving the sub-pixel 511 to be maintained off during a second turn-off period. A second display period corresponding to the second refresh rate includes the second turn-on period and the second turn-off period adjacent to each other.

In some embodiments, the gate driving circuit 530 includes a plurality of cascaded gate driving units. Each of the gate driving units is connected to a clock signal and outputs a scanning signal. The timing controller 520 is further configured for: for each sub-pixel 511 in the picture to be displayed on the display panel 510, inputting a second timing signal corresponding to the sub-pixel 511 to the gate driving unit in the gate driving circuit 530. Each of the gate driving units in the gate driving circuit 530 is configured for: determining a second scanning signal corresponding to the sub-pixel 511 according to the second timing signal corresponding to the sub-pixel 511; and according to the second scanning signal corresponding to the sub-pixel 511, driving the sub-pixel 511 to be maintained on during the second turn-on period, and driving the sub-pixel 511 to be maintained off during the second turn-off period.

In some embodiments, the first display period is greater than the second display period, and the first turn-on period is greater than the second turn-on period.

In some embodiments, the first display period is greater than the second display period. and the first turn-off period is greater than the second turn-off period.

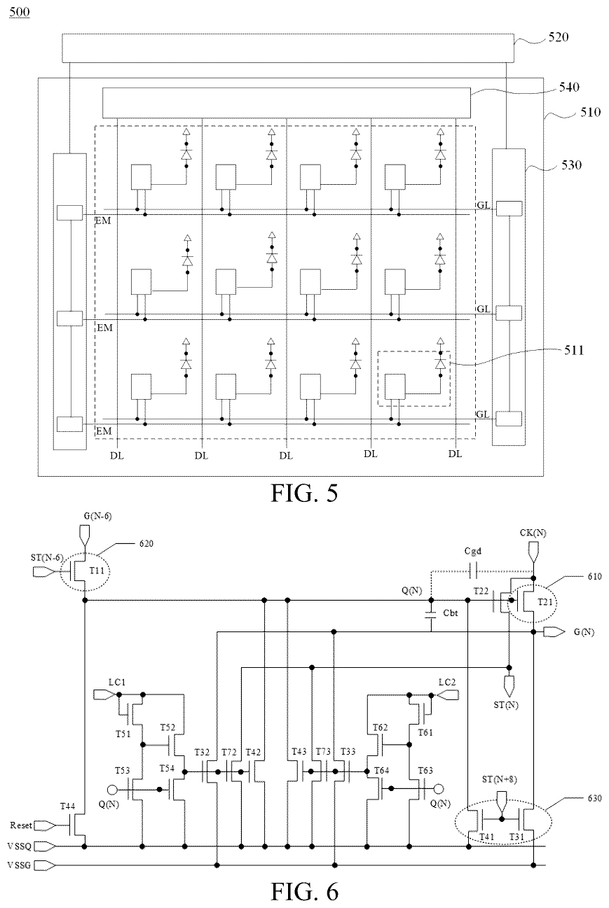

Exemplarily, as shown in FIG. 6, a pull-up module 610 of a N-th stage gate driving unit includes a transistor T21. The transistor T21 is provided with a N-th clock signal CK(N) and outputs a N-th scanning signal G(N). A pull-up control module 620 of the N-th stage gate driving unit includes a transistor T11. The transistor T11 is provided with a (N−6)-th scanning signal G(N−6). A pull-down module 630 of the N-th stage gate driving unit includes a transistor T31 and a transistor T41. The transistor T31 and the transistor T41 are provided with a (N+8)-th scanning signal G(N+8) or a (N+8)-th stage transmission signal ST (N+8).

The display panel 510 in the display device 500 includes at least twelve clock signals from CK1 to CK12. That is, the sub-pixels from a first row of sub-pixels to a twelfth row of sub-pixels in the display panel 510 are divided into a group of sub-pixels. The twelve clock signals are connected to twelve rows of sub-pixels in the group of sub-pixels in one-to-one correspondence through the first scanning lines GL1 to the twelfth scanning lines GL12.

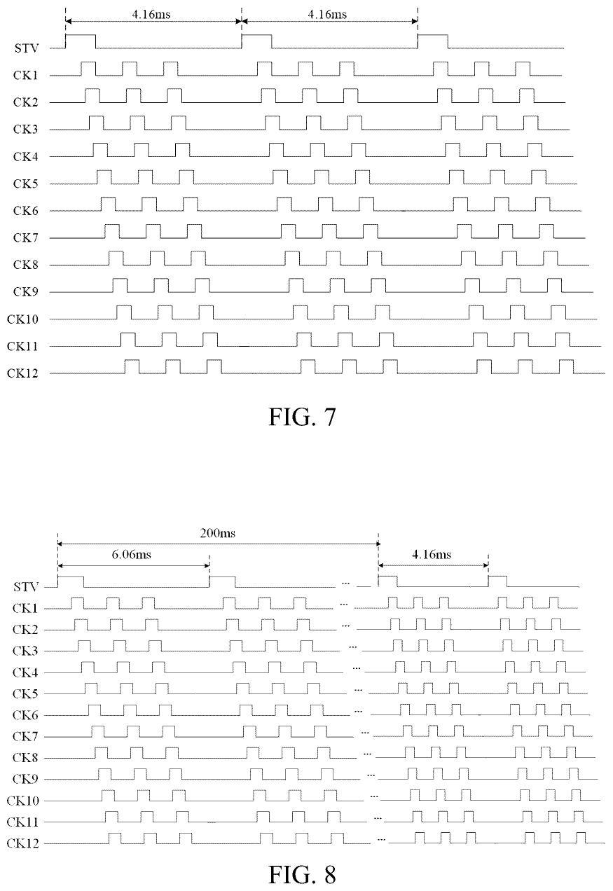

Exemplarily, according to the control method of the display device as illustrated in FIG. 4, under the condition that the display device is applied to the normal temperature scene, a driving timing of the gate driving circuit is input by the timing controller, as illustrated in FIG. 7, and the twelve clock signals from CK1 to CK12 are sequentially delayed. At a refresh rate of 240 Hz, the first display period of each sub-pixel is 4.16 ms.

Exemplarily, according to the control method of the display device as illustrated in FIG. 4, under the condition that the display device is applied to the low-temperature scenes, a driving timing of the gate driving circuit is input by the timing controller, as illustrated in FIG. 8, and the twelve clock signals from CK1 to CK12 are sequentially delayed. When the refresh rate is higher, a period of the clock signal is shorter. When the refresh rate is lower, the period of the clock signal is longer. At a refresh rate of 165 Hz, the first display period of each sub-pixel is 6.06 ms. When the refresh rate of 165 Hz is sustained for 200 ms, the refresh rate of 165 Hz is switched to the refresh rate of 240 Hz. At the refresh rate of 240 Hz, the second display period of each sub-pixel is 4.16 ms. As shown in FIG. 8, the sub-pixel is turned on at a high level and turned off at a low level. The first turn-on period in the first display period is greater than the second turn-on period in the second display period, and the first turn-off period in the first display period is greater than the second turn-off period in the second display period.

In summary, in the display device provided by the embodiments of the present disclosure, the picture of the display panel is controlled to be refreshed according to a smaller refresh rate during the power-on process, and the smaller refresh rate is switched to a larger refresh rate after the power-on process, so as to ensure the display effect after the display panel is powered on. Since the smaller refresh rate is adopted during the power-on process, a charging time of a thin film transistor during the power-on process can be prolonged. Especially for the low-temperature scenes, the thin film transistor can be normally turned on by prolonging the charging time, thereby ensuring that the display device can be normally powered on. In the embodiments of the present disclosure, there is no need to add a temperature compensation circuit to compensate for a gate on voltage of the thin film transistor, and the problem that the display device cannot be powered on normally in the low-temperature scenes can be solved based on an existing power management integrated circuit, thereby effectively saving the cost of the display device.

Functions of each module in the display device, such as functions of the timing controller, can be referred to in the above detailed description of the control method of the display device, and will not be repeatedly described herein.

A display device and a control method thereof provided by the embodiments of the present application have been described in detail above, the principles and embodiments of the present application have been described herein by applying specific examples, and the description of the above embodiments is only for helping to understand the technical solutions of the present application and the core ideas thereof. In addition, for those skilled in the art, there will be changes in the specific implementations and the scope of application based on the ideas of the present disclosure. In summary, the content of the description should not be understood as limiting the present disclosure.

What is claimed is:

1. A control method of a display device, comprising:
in response to a power-on instruction, refreshing a picture required to be displayed on a display panel according to a first refresh rate; and
in response to satisfying a target condition, refreshing a picture required to be displayed on the display panel at a second refresh rate;
wherein the first refresh rate is less than the second refresh rate.

2. The control method according to claim 1, wherein the target condition comprises that the picture is displayed on the display panel.

3. The control method according to claim 2, wherein the target condition comprises that the first refresh rate has been sustained for a preset duration.

4. The control method according to claim 1, wherein the step of in response to the power-on instruction, refreshing the picture required to be displayed on the display panel according to the first refresh rate comprises:
in response to the power-on instruction, obtaining an ambient temperature of the display panel; and
under a condition that the ambient temperature is less than a preset temperature, refreshing the picture required to be displayed on the display panel according to the first refresh rate.

5. The control method according to claim 4, wherein after the step of in response to the power-on instruction, obtaining the ambient temperature of the display panel, the control method further comprises:
under a condition that the ambient temperature is greater than the preset temperature, refreshing the picture required to be displayed on the display panel according to the second refresh rate.

6. The control method according to claim 1, wherein the step of refreshing the picture required to be displayed on the display panel according to the first refresh rate comprises:
for each sub-pixel in the picture to be displayed on the display panel, driving the sub-pixel to be maintained on during a first turn-on period and driving the sub-pixel to be maintained off during a first turn-off period;
wherein a first display period corresponding to the first refresh rate comprises the first turn-on period and the first turn-off period adjacent to each other.

7. The control method according to claim 6, wherein the step of refreshing the picture required to be displayed on the display panel at the second refresh rate comprises:
for each sub-pixel in the picture to be displayed on the display panel, driving the sub-pixel to be maintained on during a second turn-on period and driving the sub-pixel to be maintained off during a second turn-off period;
wherein a second display period corresponding to the second refresh rate comprises the second turn-on period and the second turn-off period adjacent to each other.

8. The control method according to claim 7, wherein the first display period is greater than the second display period.

9. The control method according to claim 7, wherein the first turn-on period is greater than the second turn-on period; and/or, the first turn-off period is greater than the second turn-off period.

10. A display device, comprising a display panel and a timing controller, wherein the timing controller is configured for:
in response to a power-on instruction, refreshing a picture required to be displayed on a display panel according to a first refresh rate; and
in response to satisfying a target condition, refreshing a picture required to be displayed on the display panel at a second refresh rate;
wherein the first refresh rate is less than the second refresh rate.

11. The display device according to claim 10, wherein the target condition comprises that the picture is displayed on the display panel.

12. The display device according to claim 11, wherein the target condition comprises that the first refresh rate has been sustained for a preset duration.

13. The display device according to claim 10, wherein the
timing controller is further configured for:
in response to the power-on instruction, obtaining an ambient temperature of the display panel; and
under a condition that the ambient temperature is less than a preset temperature, refreshing the picture required to be displayed on the display panel according to the first refresh rate.

14. The display device according to claim 13, wherein the timing controller is further configured for:
under a condition that the ambient temperature is greater than the preset temperature, refreshing the picture required to be displayed on the display panel according to the second refresh rate.

15. The display device according to claim 10, wherein the display device further comprises a gate driving circuit electrically connected to the timing controller, and the gate driving circuit is configured for:
for each sub-pixel in the picture to be displayed on the display panel, driving the sub-pixel to be maintained on during a first turn-on period and driving the sub-pixel to be maintained off during a first turn-off period;
wherein a first display period corresponding to the first refresh rate comprises the first turn-on period and the first turn-off period adjacent to each other.

16. The display device according to claim 15, wherein the gate driving circuit comprises a plurality of gate driving units in a cascaded configuration, and each of the plurality of gate driving units is further configured for:
determining a first scanning signal corresponding to the sub-pixel according to a first timing signal corresponding to the sub-pixel; and
according to the first scanning signal corresponding to the sub-pixel, driving the sub-pixel to be maintained on during the first turn-on period, and driving the sub-pixel to be maintained off during the first turn-off period.

17. The display device according to claim 16, wherein the gate driving circuit is further configured for:
for each sub-pixel in the picture to be displayed on the display panel, driving the sub-pixel to be maintained on during a second turn-on period and driving the sub-pixel to be maintained off during a second turn-off period;
wherein a second display period corresponding to the second refresh rate comprises the second turn-on period and the second turn-off period adjacent to each other.

18. The display device according to claim 17, wherein the gate driving circuit comprises a plurality of gate driving units in a cascaded configuration, and each of the plurality of gate driving units is further configured for:
determining a second scanning signal corresponding to the sub-pixel according to a second timing signal corresponding to the sub-pixel; and
according to the second scanning signal corresponding to the sub-pixel, driving the sub-pixel to be maintained on during the second turn-on period, and driving the sub-pixel to be maintained off during the second turn-off period.

19. The display device according to claim 17, wherein the first display period is greater than the second display period.

20. The display device according to claim 17, wherein the first turn-on period is greater than the second turn-on period; and/or, the first turn-off period is greater than the second turn-off period.
